(19) United States
(12) Patent Application Publication
(10) Pub. No.: US 2009/0298630 A1
(43) Pub. Date: Dec. 3, 2009

(54) PULLEY FIXING STRUCTURE

(76) Inventors: Katsunori MINENO, Iwata (JP); Goro Nakao, Iwata (JP)

Correspondence Address: WENDEROTH, LIND & PONACK, L.L.P., 1030 15th Street, N.W.,, Suite 400 East, Washington, DC, 20005-1503, US

(21) Appl. No.: 12/472,493

(22) Filed: May 27, 2009

(30) Foreign Application Priority Data
May 28, 2008 (JP) 2008-139494

(51) Int. Cl. F16H 55/36

(52) U.S. Cl. 474/199

(57) ABSTRACT

A pulley fixing structure includes a pulley with a ball bearing, and a bracket having a shaft portion on which the inner race of the bearing is pressed with an interference fit. The thermal expansion of the radially outer portion of the shaft portion of the bracket is larger than that of the radially inner portion of the inner race of the bearing. The interference thus decreases at a low temperature. Reduction of the radial clearance of the bearing 1 by pressing is thus compensated, and cold weather noise can be prevented while reducing the number of required parts and making the assembly process simple.

### BACKGROUND OF THE INVENTION

This invention relates to a pulley fixing structure for fixing a ball bearing with a pulley to a shaft portion of a bracket.

Some pulleys that contact an automobile timing belt or a belt for driving engine accessories include a ball bearing having an inner race fitted around a shaft portion of a bracket mounted e.g. to an engine casing, with its end surface on the deep side pressed against a shoulder on the proximal portion of the shaft portion, thereby fixing the inner race (and thus the pulley) in position.

To fix this type of pulley, the inner race of the ball bearing is fixed by tightening a bolt (e.g. JP 07-317783A), or the inner race of the ball bearing is crimped (e.g. JP 2007-40368A). Also the inner race may be pressed onto the shaft portion to fix the inner race.

Automobile pulleys described above may generate whistle-like noise when the automobile is driven at a low temperature. This noise, which is known as cold weather noise, occurs in limited areas where the temperature drops below freezing, such as in Hokkaido, Japan, for a short, limited time (about 1 minute maximum) just after starting the vehicle engine.

The cause of this cold weather noise has not been definitely clarified. However, from various experiments, this noise is supposed to be caused mainly by self-excited vibration of the balls of the ball bearing. At low temperature, the viscosity of grease base oil increases and oil film on the raceways tends to become uneven. This leads to fluctuations in coefficient of friction between the balls and the raceway in a short cycle, which causes self-excited vibration of the balls. By this self-excited vibration of the balls, the pulley system, including the outer race of the ball bearing, resonates at a high frequency in the axial direction, and this is supposed to cause cold weather noise.

To prevent this cold weather noise, some means proposed and found effective include: using a grease that forms il film on a metal surface even at low temperature for a grease to be sealed in the ball bearing (see JP 09-208982A for example); making the radial clearance of the ball bearing wider to increase contact pressure of the balls in the loading area, thereby increasing the bearing stiffness in the axial direction (see JP 09-72403A for example); bringing each ball of the ball bearing into contact with the outer race at two points to form a contact angle (see JP 11-270566A for example); and offsetting the center of the belt wrapped around the pulley from the center of the ball bearing, thereby inclining the raceways of the inner and outer races relative to each other (see JP 08-178024A for example).

In the pulley fixing structure described in JP 07-317783A, the inner race of the ball bearing with the pulley is fitted around the shaft and fixed thereto with a bolt. Thus, this pulley fixing structure requires the bolt and a washer, and may require a nut too, and thus the number of required parts increases. In the pulley fixing structure described in JP 2007-40368A, the inner race fitted around the shaft is fixed by crimping. In this structure, the number of required parts is small, but the crimping step is troublesome and may damage the inner race.

On the other hand, in the pulley fixing structure in which the inner race of the ball bearing with the pulley is pressed onto the shaft portion, the number of required parts is small and the assembling steps are simple. However, the radial clearance of the ball bearing is reduced by the interference when the ball bearing is pressed on, which may lead to cold weather noise described above.

An object of this invention is therefore to provide a pulley fixing structure that requires a smaller number of parts and simple assembly process and that can prevent cold weather noise.

### SUMMARY OF THE INVENTION

To achieve this object, this invention provides a pulley fixing structure comprising a ball bearing with a pulley, and a bracket including a shaft portion having a proximal portion formed with a shoulder, the ball bearing having an inner race and an outer race, the inner race being pressed onto the shaft portion with an interference fit and with one end surface thereof pressed against the shoulder, the shaft portion having a radially outer portion and the inner race having a radially inner portion that is in contact with the radially outer portion of the shaft portion, the radially outer portion of the shaft portion having a larger thermal expansion than the radially inner portion of the inner race.

With this arrangement, because the thermal expansion of the radially outer portion of the shaft portion is larger than the thermal expansion of the radially inner portion of the inner race, and the inner race is pressed onto the shaft portion with an interference fit, the interference is low when the temperature is low. Reduction of the radial clearance of the bearing by pressing is thus compensated, and cold weather noise can be prevented while reducing the number of required parts and making the assembling step simple and easy.

To make the thermal expansion of the radially outer portion of the shaft portion larger than the thermal expansion of the radially inner portion of the inner race, the shaft portion may be made of a metal having a larger linear expansion coefficient than the metal of the inner race.

To make the thermal expansion of the radially outer portion of the shaft portion larger than the thermal expansion of the radially inner portion of the inner race, a sleeve made of a metal having a larger linear expansion coefficient than said inner race may be pressed around the shaft portion.

The interference between the inner race and the shaft portion is preferably set to zero at −10° C. or lower. With this arrangement, because Cold weather noise generally occurs at −10° C. or lower, and at such low temperature, reduction of radial clearance due to pressing is compensated to virtually zero.

By providing means to prevent the inner race from coming off the shaft portion, the bearing is prevented from coming off even when the interference of the inner race becomes zero at a low temperature.

### BRIEF DESCRIPTION OF THE DRAWINGS

FIG. 1 is a vertical sectional front view of a pulley fixing structure according to a first embodiment of the present invention; and

FIG. 2 is a vertical sectional front view of a pulley fixing structure according to a second embodiment of the present invention.

### DETAILED DESCRIPTION OF THE PREFERRED EMBODIMENTS

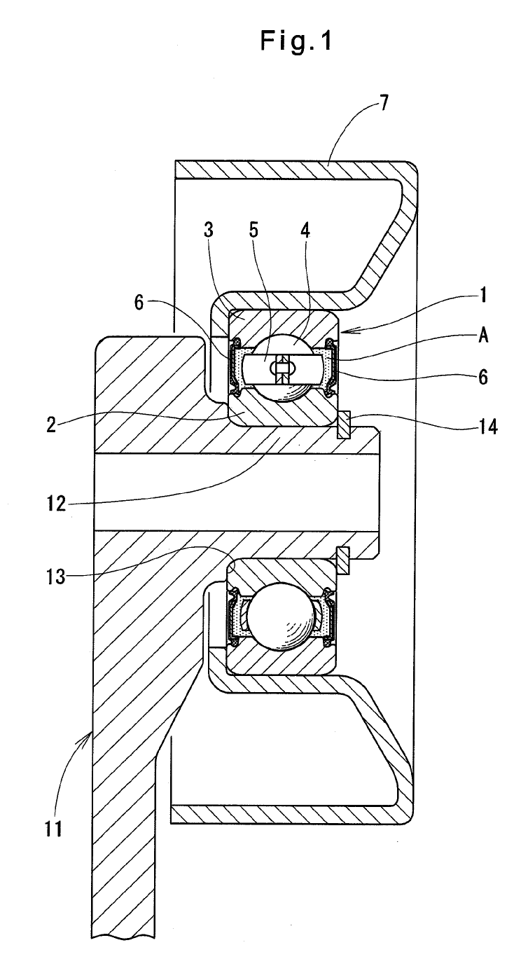

Now referring to the drawings, FIG. 1 shows the pulley fixing structure according to the first embodiment, wherein an inner race 2 of a ball bearing 1 with a pulley 7 is pressed around a shaft portion 12 of a bracket 11 with an interference fit. A deep end surface of the inner race 2 is pressed against a shoulder 13 provided on the proximal portion of the shaft portion 12. A snap ring 14 prevents the inner race 2 from coming off the shaft portion 13. But instead, the inner race 2 may be prevented from coming off the shaft portion 13 by tightening a bolt.

The ball bearing 1 includes the inner race 2, an outer race 3, and a plurality of balls 4 provided between the inner and outer races 2 and 3 and retained by a retainer 5. The bearing space is filled with grease A and sealed by seal members 6. A metal pulley 7 is fixedly mounted to the outer race 3. The inner and outer races 2 and 3 and the balls 4 are all made of high carbon chrome SUJ2 (1.17×10⁻⁵ in linear expansion coefficient). The radial clearance of the ball bearing 1 before pressed onto the shaft portion is set to 10 μm.

The bracket 11 is attached to e.g., a casing of an automobile engine. The bracket 11, including the shaft portion 12, is made of a cast aluminum alloy (2.35×10⁻⁵ in linear expansion coefficient). In this embodiment, the interference between the inner race 2 and the shaft portion 12 at the former is pressed on the latter is determined such that it is 0 μm at −10° C. Therefore, at room temperature or higher temperature, the ball bearing 1 operates with a radial clearance smaller than 10 μm, which is the radial clearance before the inner race is pressed onto the shaft portion. The radial clearance increases as the temperature decreases. When the temperature drops to −10° C. or lower, the bearing operates with a radial clearance of 10 μm, which is the radial clearance before the inner race is pressed onto the shaft portion.

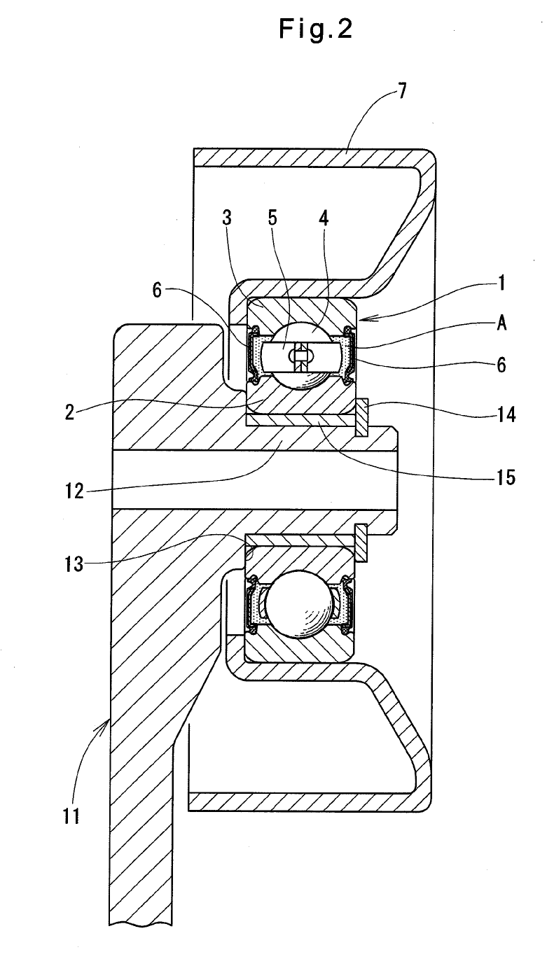

FIG. 2 shows the pulley fixing structure according to the second embodiment. This pulley fixing structure is basically the same as the first embodiment. The only differences are that the bracket 11 is made of cast iron, that a sleeve 15 made of austenitic stainless steel (1.73×10⁻⁵ in linear expansion coefficient) is pressed onto the shaft portion 12, and that the inner race 2 of the ball bearing 1, which is made of carbon chrome steel SUJ2, is pressed onto the sleeve 15 with an interference fit. Otherwise, the second embodiment is identical to the first embodiment.

While the pulleys of the above embodiments are made of metal in the, these pulleys may be made of resin, and their forms are not limited to those in the embodiments.

What is claimed is:

1. A pulley fixing structure comprising a ball bearing with a pulley, and a bracket including a shaft portion having a proximal portion formed with a shoulder, said ball bearing having an inner race and an outer race, said inner race being pressed onto said shaft portion with an interference fit and with one end surface thereof pressed against said shoulder, said shaft portion having a radially outer portion and said inner race having a radially inner portion that is in contact with said radially outer portion of said shaft portion, said radially outer portion of said shaft portion having a larger thermal expansion than said radially inner portion of said inner race.

2. The pulley fixing structure according to claim 1, wherein the thermal expansion of the radially outer portion of diameter of said shaft portion is made larger than the thermal expansion of the radially inner portion of said inner race by making said shaft portion from a metal having a larger linear expansion coefficient than a metal of said inner race.

3. The pulley fixing structure according to claim 1, wherein the thermal expansion of the radially outer portion of said shaft portion is made larger than the thermal expansion of the radially inner portion of said inner race by providing a sleeve pressed onto said shaft portion and made of a metal having a larger linear expansion coefficient than said inner race.

4. The pulley fixing structure according to claim 1, wherein the interference between said inner race and said shaft portion is set to zero at −10° C. or lower.

5. The pulley fixing structure according to claim 2, wherein the interference between said inner race and said shaft portion is set to zero at −10° C. or lower.

6. The pulley fixing structure according to claim 3, wherein the interference between said inner race and said shaft portion is set to zero at −10° C. or lower.

7. The pulley fixing structure according to claim 1, further comprising means for preventing said inner race from coming off said shaft portion.

8. The pulley fixing structure according to claim 2, further comprising means for preventing said inner race from coming off said shaft portion.

9. The pulley fixing structure according to claim 3, further comprising means for preventing said inner race from coming off said shaft portion.

10. The pulley fixing structure according to claim 4, further comprising means for preventing said inner race from coming off said shaft portion.

11. The pulley fixing structure according to claim 5, further comprising means for preventing said inner race from coming off said shaft portion.

12. The pulley fixing structure according to claim 6, further comprising means for preventing said inner race from coming off said shaft portion.
